(19) United States
(12) Patent Application Publication
(10) Pub. No.: US 2012/0242460 A1
(43) Pub. Date: Sep. 27, 2012

(54) METHOD AND SYSTEM FOR IDENTIFYING ITEMS

(75) Inventors: Gerhard Frederick Swiegers, Thirroul (AU); Benjamin William Bootle, Cabarita (AU); Geoffrey Michael George, Epping (AU)

(73) Assignee: DataDot Technology Limited, Frenchs Forest (AU)

(21) Appl. No.: 13/499,609

(22) PCT Filed: Sep. 29, 2010
(86) PCT No.: PCT/AU2010/001281

§ 371 Date: Jun. 6, 2012

(30) Foreign Application Priority Data
Oct. 2, 2009 (AU) 2009904812

(51) Int. Cl. H04Q 5/22

(52) U.S. Cl. 340/10.42

(57) ABSTRACT

Methods and systems for identifying items are disclosed. One such method comprises the steps of: subjecting at least a portion of the item to a predefined activating condition (610); determining the location of at least one taggant associated with the item by detecting a response to the predefined activating condition (620); retrieving data from the at least one taggant using the determined location (630); and processing the data to uniquely identify the item (640). The at least one taggant is adapted to be substantially imperceptible by a human being in the absence of the predefined activating condition.

### TECHNICAL FIELD

The present invention relates to taggants bearing data such as microscopic visual indicia, and systems and methods for retrieving the data from such taggants. Such taggants may, for example, be used to identify items and/or verify the legitimacy and origin of items to which they are attached or within which they are incorporated.

### RELATED APPLICATION

This application claims priority from Australian Provisional Patent Application No. 2009904812, filed on 2 Oct. 2009, the contents of which are incorporated herein by way of reference.

### BACKGROUND

Taggants and other identification devices are commonly attached to or incorporated within items of value in order to identify ownership or origin and to hinder theft, diversion, or illegal use of such items. Typical examples of such items include, but are not limited to, motor vehicles, motorcycles, machinery, equipment, branded products, spirits, high-value consumer goods, documents, storage media, and financial and other instruments.

Since at least sixty years ago, exceedingly small photographic reproductions have been employed to confidentially communicate sensitive information. In such techniques, letter-sized documents have, for example, been copied onto a “microdot” (taggant) no larger than a typewritten period. Such a microdot is then physically hidden as a period in a written or typewritten communication. The data borne by the microdot may be read by observing the microdot using a suitable microscope or other optical magnification means. Microdots of this type are typically circular, being approximately 1 millimetre in diameter with a thickness of a fraction of a millimetre.

Microdots of the type referred to above typically have flat surfaces bearing repetitive identifying indicia, such as numeric and alpha-numeric characters, which can be visually interpreted under magnification. The indicia, whose smallest features (e.g., the middle stroke on a capital “E” character) are typically 2-5 micrometres in size, may provide part or all of a code that uniquely identifies the object to which a microdot is attached. On account of being exceedingly small, such microdots are generally not readily apparent to the naked human eye when attached to an item of value. Multiple microdots may be attached at different locations on the item, thus making complete removal of the microdots effectively impossible and thereby hindering attempts to hide the ownership or origin of the item.

While microparticles and other tagging devices of small dimensions (referred to generically herein as “taggants”) bearing microscopic visual indicia provide an effective means of identifying items, such taggants constitute forensic markers which are not generally amenable to routine interrogation. By this is meant that the identity of items marked with such taggants can only be assessed using a forensic detection process in which the item is carefully inspected using a powerful magnifying optic. In particular, considerable effort may be required to locate a taggant on an item of interest. This procedure is typically time-consuming and inconvenient. It may also be invasive and sometimes destructive if the taggant is incorporated within the item or the surface layer of the item. For example, microdots present on an automobile have to be located, scratched off, and collected for visual inspection under a microscope.

A need therefore exists for a non-invasive method to rapidly and conveniently locate taggants associated with an item and retrieve data from such taggants to identify the item.

### SUMMARY

An aspect of the present invention provides a method for identifying an item. The method comprises the steps of: subjecting at least a portion of the item to a predefined activating condition; determining the location of at least one taggant associated with the item by detecting a response to the predefined activating condition; retrieving data from the at least one taggant using the determined location; and processing the data to uniquely identify the item. The at least one taggant is adapted to be substantially imperceptible by a human being in the absence of the predefined activating condition.

The at least one taggant may be substantially undetectable by a human being in the absence of the predefined activating condition.

The at least one taggant may be of sufficiently small dimensions to be unidentifiable by a human being in the absence of the predefined activating condition.

The at least one taggant may be attached to, or be incorporated in, the item.

The data may be retrieved from the at least one taggant by magnifying and reading the data.

The at least one taggant may be located by: detecting luminescence emitted in response to illumination by light of a particular wavelength; detecting a magnetic signature emitted in response to activation by a magnet or magnetic detector; detecting a reflective signature emitted in response to illumination by electromagnetic radiation of a particular wavelength; detecting an electromagnetic signature in a region of the electromagnetic spectrum that is humanly undetectable; detecting an induced electrical current in a polarised electric coil disposed in close proximity to the at least one taggant; detecting a polarisation signature emitted by the at least one taggant in response to the predefined activating condition; detecting an audio signature emitted by the at least one taggant in response to the predefined activating condition; detecting a resonance signature generated by the predefined activating condition; and/or detecting an absorption signature resulting from the predefined activating condition.

Another aspect of the present invention provides a method for facilitating identification of an item. The method comprises the steps of: providing a plurality of taggants for associating with the item, each of the plurality of taggants comprising identical data for uniquely identifying the item; and adapting the plurality of taggants to emit a response to a predefined activating condition. The plurality of taggants is of sufficiently small dimensions to be substantially imperceptible to a human being in the absence of the predefined activating condition.

The step of adapting the plurality of taggants may comprise applying a coating to the plurality of taggants or overprinting the plurality of taggants with an ink.

Another aspect of the present invention provides an item comprising a plurality of taggants. Each of the taggants comprises identical data for uniquely identifying the item. Each of the taggants is adapted to: (i) emit a response when subjected to a predefined activating condition; and (ii) be substantially imperceptible to human beings in the absence of the predefined activating condition.

The at least one taggant may be substantially undetectable by human beings in the absence of the predefined activating condition.

The at least one taggant may be of sufficiently small dimensions to be unidentifiable by human beings in the absence of the predefined activating condition.

In certain embodiments, the largest dimension of the taggant/s is less than 1 mm.

In certain embodiments, the taggant/s comprise/s microdots. In certain embodiments, the largest dimension of the microdots may be less than 100 μm.

### BRIEF DESCRIPTION OF THE DRAWINGS

A small number of embodiments of the present invention are hereinafter described, by way of example only, with reference to the accompanying drawings in which:

FIG. 1 shows a microdot comprising multiple lines of data;

FIG. 2 shows a metallised microdot comprising a code number;

FIG. 3 shows a metallised holographic microdot;

FIG. 4 shows a commercially available portable video microscope;

FIG. 5 shows several microdots glowing visibly in response to being illuminated or irradiated with a luminescent signature comprising UV light;

FIG. 6 is a flowchart of a method for identifying an invention in accordance with an embodiment of the present invention; and

FIG. 7 is a flowchart of a method for facilitating identification of an item in accordance with an embodiment of the present invention.

### DETAILED DESCRIPTION

For the sake of convenience, the examples and embodiments described hereinafter are described with reference to automobiles or vehicles as being high-value items of interest to which taggants are affixed or attached in accordance with embodiments of the present invention. However, the skilled reader will appreciate that the use of automobiles is illustrative only and is not intended to limit the present invention in any way. Any and all items to which taggants may be attached or incorporated in may be substituted for automobiles in the following examples and embodiments.

Taggants used in embodiments of the present invention include, but are not limited to, small tagging devices such as microparticles and microdots that typically bear microscopic visual indicia.

In certain instances, a unique code may be stored as data on a microdot and used in conjunction with a verification database to identify an item or asset the microdot is applied to (or, for example, the owner of the item or asset). In other instances, the microdot may simply bear an identifier of the actual item or asset, for example, the full Vehicle Identification Number (VIN) issued by a car manufacturer.

Taggants used in embodiments of the present invention require activation for determining their location. The taggants are “substantially imperceptible” or “substantially undetectable” by human beings in the absence of a predefined activating condition. The phrase “substantially imperceptible” is intended to convey that while the taggants may be visible to a human being if closely or carefully searched for, the taggants will not generally be noticable or perceivable by human beings when not specifically searched for. One factor that significantly contributes to this characteristic is small physical dimensions of the taggants. For example, a taggant the size of a period (full stop) may be imperceptible or unidentifiable to a human being on a page of text or on an item. Even smaller taggants may be perceived as specks of dirt, etc. and thus be imperceptible or unidentifiable as taggants to human beings.

In certain embodiments, the largest dimension of the taggant/s is less than 1 mm. In certain embodiments, the taggant/s comprise/s microdots. Typical microdot sizes include, but are not limited to, 1000 μm, 500 μm, 300 μm and 100 μm. In certain embodiments, the largest dimension of the microdots may be less than 100 μm.

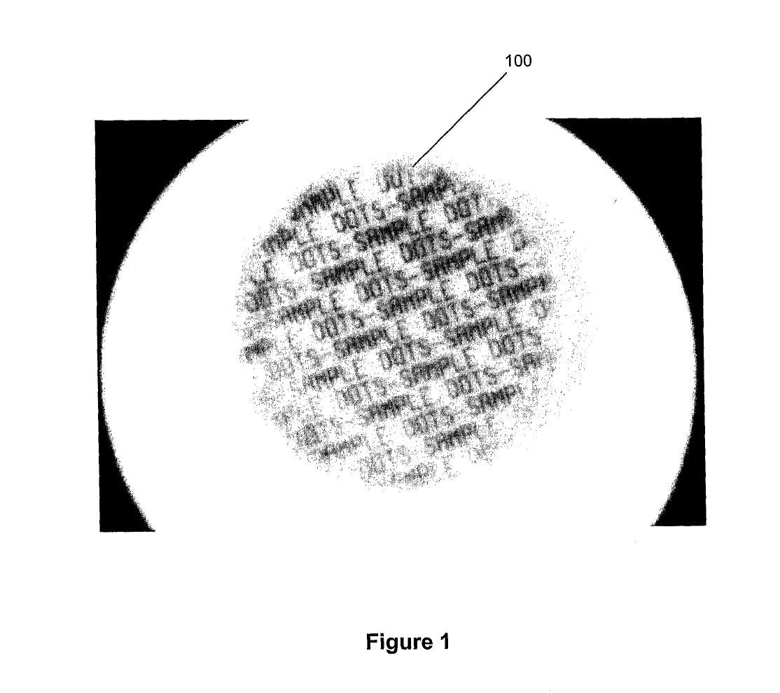

FIG. 1 shows an example of a microdot 100 under magnification by an optical microscope. The microdot 100 shown in FIG. 1 comprises a tiny polymer disc laser-etched with multiple lines of code or text, and is available from DataDot Technology (Australia) Pty Ltd. More information can be obtained at the URL: (www.datadotdna.com/australia/dtal technology indetail dot.htm).

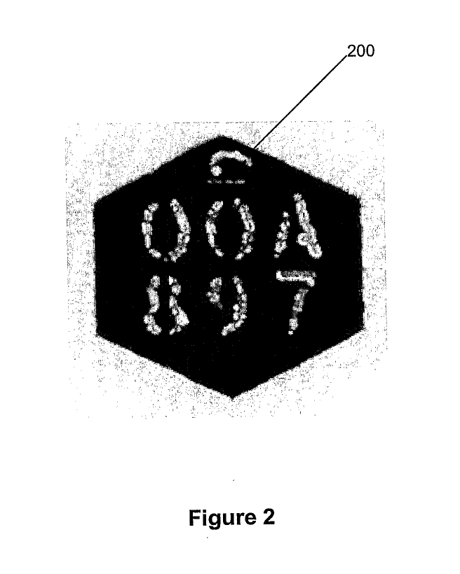

FIG. 2 shows a metallised microdot 200, also under optical magnification. The microdot 200, also available from DataDot Technology (Australia) Pty Ltd, has a two-line code (00A, 897) stored thereon. The code may be retrieved by optically magnifying and reading the microdot 200.

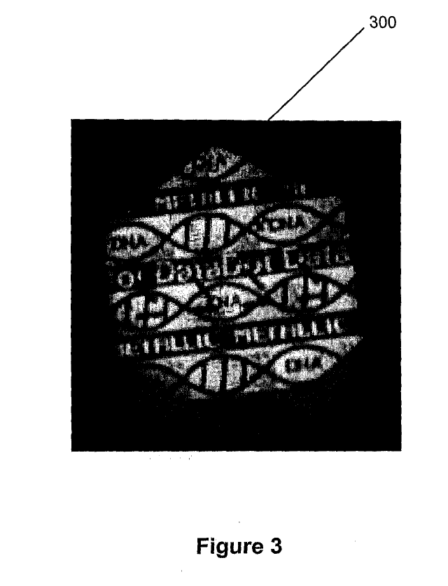

FIG. 3 shows a metallised holographic microdot, also under optical magnification. The microdot 300, also available from DataDot Technology (Australia) Pty Ltd, has multiple lines of text and patterns stored thereon. The code may be retrieved by optically magnifying and reading the microdot 200.

The microdots shown in FIGS. 1-3 are examples of microdots used in certain embodiments of the present invention. However, those skilled in the art will appreciate that numerous other suitable microdots and/or other taggants may alternatively be used to practise embodiments of the present invention.

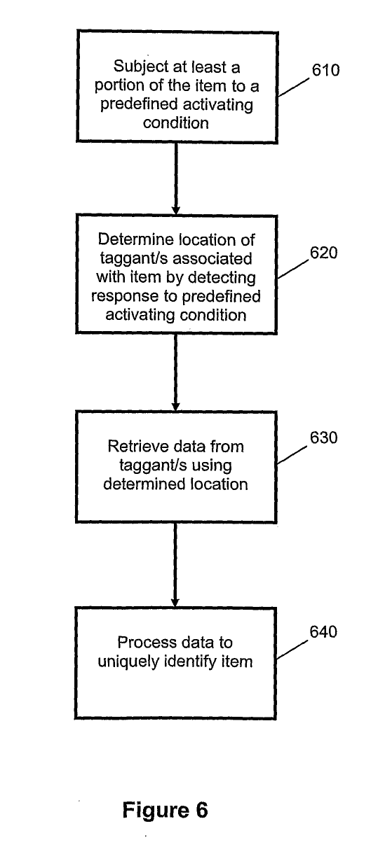

FIG. 6 is a flowchart of a method for identifying an item in accordance with an embodiment of the present invention.

Referring to FIG. 6, at least a portion of the item is subjected to a predefined activating condition at step 610. Examples of such predefined activating conditions are described hereinafter.

At step 620, the location of at least one taggant associated with the item is determined by detecting a response to the predefined activating condition.

Using the determined location of the taggant, data is retrieved from the taggant at step 630. The data is processed at step 640 to uniquely identify the item.

The taggants are adapted to be substantially imperceptible by human beings in the absence of the activating condition.

The taggants may be attached to or incorporated within the item. Furthermore, the taggants may be of sufficiently small physical dimensions to be unidentifiable by human beings in the absence of the predefined activating condition.

The step of retrieving data from a taggant may, for example, comprise optically magnifying and reading the data. This step may be machine-automated, partially machine-automated, or may be performed manually by a human being with an optical magnification instrument.

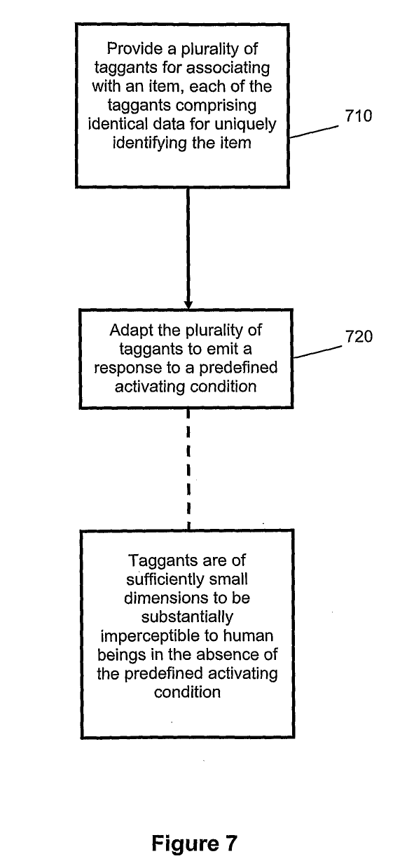

FIG. 7 is a flowchart of a method for facilitating identification of an item in accordance with an embodiment of the present invention.

Referring to FIG. 7, a plurality of taggants for associating with the item is provided at step 710. Each of the plurality of taggants comprises data for uniquely identifying the item.

At step 720, the plurality of taggants is adapted to emit a response to a predefined activating condition.

The plurality of taggants is of sufficiently small physical dimensions to be substantially imperceptible or undetectable by human beings in the absence of the predefined activating condition.

The following examples relate to embodiments of the present invention and may be practiced in conjunction with the methods described hereinbefore with reference to FIGS. 6 and 7. However, the following examples should not be construed as limiting on the broadest form/s of the invention.

### Example 1

### Method of Application of Taggants

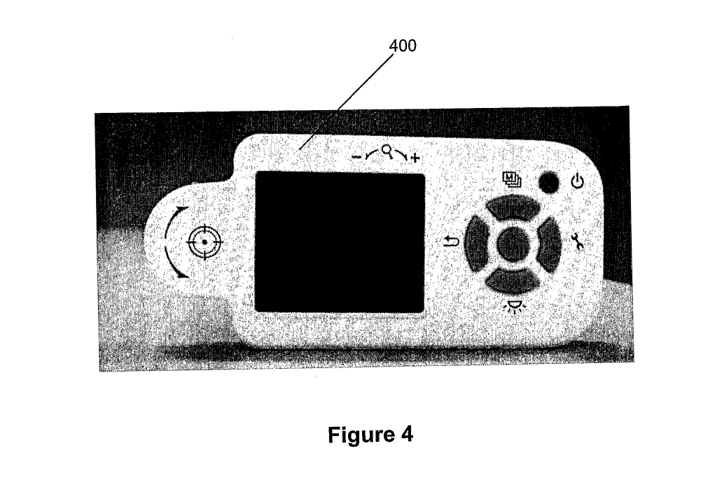

In one example application, a large number (for example, 10,000) of taggants of one of the above types are sprayed onto the underside of an automobile. Each of the taggants comprises the same data for identification of the automobile. This results in all or most of the individual components of the automobile being marked with the data contained in or on the taggants. In effect, the taggant acts as a micro-label that labels each part of the vehicle. The large numbers of taggants make it impossible or very difficult for thieves to remove all of the taggants. The data may be retrieved from one or more of the taggants using optical magnification in the form of, for example, a simple optical microscope or a portable video microscope 400 of the type shown in FIG. 4 hereinafter.

In accordance with embodiments of the present invention, prior to being sprayed onto an automobile, the taggants are pre-treated by either coating with, or incorporating within them, a material or substance that imparts a particular signature to the taggants. In so doing, the material or substance becomes an integral part of the taggant, so that the properties of the added material or substance also become those of the taggant. The signature is readable or detectable only when a suitable activating condition is created or applied.

After the automobile or other item has been sprayed with multiple taggants, the automobile may be searched for the presence of the taggants and to determine the location of the individual taggants. This involves examining the automobile under a suitable activating condition, in order to activate the characteristic signature of the material or substance that has been affixed to, or incorporated within the taggants.

Wherever the material is found, a taggant will be present. Located taggants can be examined using an optical microscope or a video microscope to retrieve or read the data or visual indicia on the taggant. The process of uniquely identifying the automobile and all of its various marked components is thereby considerably simplified.

### Example 2

### Locating Taggants using a Luminescent Signature

During manufacture, taggants of the type made by DataDot Technology are imparted with a luminescent signature by overprinting the taggants with an ink comprising a luminescent material. Examples of commercially available luminescent materials that may be used include, but are not limited to: UV-Tex™ and Tinopal™ (manufactured by Ciba), Blankophor® (manufactured by Bayer), Leucophor® (manufactured by Clariant) and Photine® (manufactured by Hickson and Welch). Examples of other suitable luminescent materials include, but are not limited to, the luminescent materials described in International (PCT) Publication No. WO 2006/119561, in the name of the Commonwealth Scientific and Industrial Research Organisation (Australia), published on 16 Nov. 2006, which is incorporated herein by way of reference. The presence of these materials imparts a luminescent signature to the taggants. The luminescent material has the property that it glows with light of a particular frequency when irradiated or illuminated with ultra-violet or infra-red light.

The taggants are sprayed onto an automobile and its various parts. After spraying, the taggants can be found by illuminating the automobile with a suitable UV or IR light, to thereby induce the luminescent material on the taggants to glow. The glow of the taggants can be detected using the human eye (if sufficiently bright), or using a suitable electronic detector (if it is too faint to be detected by the naked human eye).

Wherever a luminescent glow of expected intensity is observed, a taggant will have been located. A located taggant can then be examined to read the visual indicia on or in the taggant. The process of identifying the automobile and its various marked components is thereby considerably simplified.

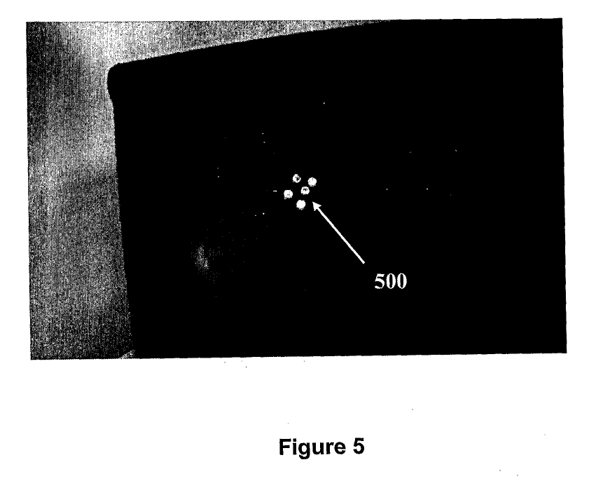

FIG. 5 shows several microdots 500 that have been imparted with a luminescent signature. When illuminated or irradiated with UV light, the microdots glow brightly as shown in FIG. 5. The glow is sufficiently bright to be seen with the naked eye, thereby revealing the location of the microdots. Once the location of the microdots is known, a video microscope of the type shown in FIG. 5 can be used to retrieve or read the data or microscopic visual indicia in or on the microdot.

### Example 3

### Locating Taggants using a Magnetic Signature

During manufacture, taggants of the type made by DataDot Technology are imparted with a magnetic signature by overprinting the taggants with a magnetic ink or incorporating a magnetic material into the taggants. Examples of commercially available magnetic inks that may be used include, but are not limited to, Magnetic Ink Character Recognition (MICR) toners, which are widely available from numerous manufacturers and suppliers.

The taggants are sprayed onto an automobile and its various parts. After spraying, the taggants may be located by scanning a magnetometer over the automobile or its parts, to thereby discover and identify the location of a magnetic signature. This process is particularly effective on plastic parts, slightly less effective on metallic parts. Wherever a magnetic signature of the expected intensity is identified, a taggant will have been located. Once a taggant has been located, data (e.g., visual indicia) may be retrieved or read from the taggant as described hereinbefore. The process of identifying the automobile and its various marked components is thereby considerably simplified.

### Example 4

### Locating Taggants using a Reflective Signature that is Visible Only in Regions of the Spectrum that Human Beings Cannot Perceive

During manufacture, taggants of the type made by DataDot Technology are imparted with a reflective signature by overprinting the taggants with an ink containing a material that is brightly reflective in the infra-red (IR) spectrum. The presence of this material imparts an IR-reflective signature to the taggants. The material has the property that it strongly reflects light of a particular infra-red frequency or wavelength when irradiated with light of that frequency or wavelength. The material does not reflect other frequencies or wavelengths.

The taggants are sprayed onto an automobile and its various parts. After spraying, the taggants may be located by illuminating or irradiating the automobile with IR light of suitable frequency or wavelength and imaging the automobile with an IR camera or other suitable detector. The reflective glow of the taggants may be observed as bright spots in the IR image, at locations where the incident IR light is reflected by the taggants.

Wherever a reflective signature of the expected intensity is observed using this technique, a taggant will be present. Once a taggant is located, data may be retrieved from the taggant as described hereinbefore. The process of identifying the automobile and its various marked components is thereby considerably simplified.

### Example 5

### Locating Taggants using an Electromagnetic Signature

During manufacture, taggants of the type made by DataDot Technology are imparted with an electromagnetic signature by overprinting the taggants with a coil-shaped feature using a highly conductive ink. Examples of commercially available conductive inks that may be used include, but are not limited to, the ELG range of silver conductive inks (manufactured by Nor-Cote International, Inc.). The presence of the resulting conduction pathway imparts an electromagnetic signature upon the taggants insofar as the taggants will induce a signature current in a metal detector located in close proximity to such taggants. That is, the printed conducting coil provides a microstrip transmission line, whose presence can be detected using a suitable electromagnetic detection system.

The taggants are sprayed onto an automobile and its various parts. After spraying, the taggants may be located by scanning the automobile with a suitable electromagnetic detection system and detecting induced currents which are indicative of such microstrip transmission lines.

Wherever the metal detector indicates the presence of a microstrip transmission line, a taggant will have been located. Data may be retrieved from located taggants as described hereinbefore. The process of identifying the automobile and its various marked components is thereby considerably simplified.

### Example 6

### Locating Taggants using Other Signatures

During manufacture, taggants of the type made by DataDot Technology may be imparted with signatures of various other types, including (but not limited to):
A polarization signature which may only be detected using suitable polarizing filters. For example, the taggant may be made to reflect or transmit light which is plane- or circularly-polarized. Such light may be detected using a polarizing filter.
An audio signature which may be heard by the human ear, or which may be detected using a suitable electronic detector, when the taggant is activated. Such activation includes, but is not limited to, irradiation or illumination with light of a particular frequency (e.g., ultraviolet light, infrared light, etc.). Other forms of activation include microwave and/or radio frequencies.
A resonance signature which can only be detected by causing a material on or in the taggant to resonate with an applied activation or stimulus. Examples include a back-scattering radio-frequency transponder that scatters incident radio-frequencies by resonating with such frequencies. Such transponders may be detected using suitable transmitting and receiving antennas.
An absorption signature which may be detected by virtue of the taggant better absorbing incident electromagnetic or other radiation than its surroundings. Examples of materials which may impart such a signature to a taggant include pigments that selectively and strongly absorb specific colours. Pigments of this type may be incorporated on or into taggants in embodiments of the present invention. The taggants may be detected by illuminating or irradiating the region with light of the desired frequency and then detecting where the light is more strongly absorbed (e.g., using a suitable filter). The taggants will typically appear as dark spots against a lighter background.

A small number of embodiments have been described hereinbefore that advantageously enable rapid and convenient location of taggants attached to, or incorporated in, an associated item. Once located, data may be retrieved from the taggants to facilitate unique identification of the associated item.

The foregoing description provides exemplary embodiments only, and is not intended to limit the scope, applicability or configurations of the invention. Rather, the foregoing description of exemplary embodiments provides those skilled in the art with enabling descriptions for implementing one or more embodiments of the invention. Various changes may be made in the function and arrangement of elements and/or features without departing from the spirit and scope of the invention as set forth in the claims hereinafter

1. A method for identifying an item, said method comprising the steps of:
subjecting at least a portion of said item to a predefined activating condition;
determining the location of at least one taggant associated with said item by detecting a response to said predefined activating condition;
retrieving data from said at least one taggant using said determined location; and
processing said data to uniquely identify said item;
wherein said at least one taggant is adapted to be substantially imperceptible by a human being in the absence of said predefined activating condition.

2. The method of claim 1, wherein said at least one taggant is substantially undetectable by a human being in the absence of said predefined activating condition.

3. The method of claim 1, wherein said at least one taggant is of sufficiently small dimensions to be unidentifiable by a human being in the absence of said predefined activating condition.

4. The method of claim 1, wherein said at least one taggant is attached to said item.

5. The method of claim 1, wherein said at least one taggant is incorporated in said item.

6. The method of claim 1, wherein said step of retrieving said data from said at least one taggant comprises the steps of magnifying and reading said data.

7. The method of claim 1, wherein said at least one taggant is located by detecting luminescence emitted in response to illumination by light of a particular wavelength.

8. The method of claim 1, wherein said at least one taggant is located by detecting a magnetic signature emitted in response to activation by a magnet or magnetic detector.

9. The method of claim 1, wherein said at least one taggant is located by detecting a reflective signature emitted in response to illumination by electromagnetic radiation of a particular wavelength.

10. The method of claim 1, wherein said at least one taggant is located by detecting an electromagnetic signature in a region of the electromagnetic spectrum that is humanly undetectable.

11. The method of claim 1, wherein said at least one taggant is located by detecting an induced electrical current in a polarised electric coil disposed in close proximity to said at least one taggant.

12. The method of claim 1, wherein said at least one taggant is located by detecting a polarisation signature emitted by said at least one taggant in response to said predefined activating condition.

13. The method of claim 1, wherein said at least one taggant is located by detecting an audio signature emitted by said at least one taggant in response to said predefined activating condition.

14. The method of claim 1, wherein said at least one taggant is located by detecting a resonance signature generated by said predefined activating condition.

15. The method of claim 1, wherein said at least one taggant is located by detecting an absorption signature resulting from said predefined activating condition.

16. The method of claim 1, wherein the largest dimension of said at least one taggant is less than 1 mm.

17. The method of claim 1, wherein said at least one taggant comprises one or more microdots.

18. The item of claim 17, wherein the largest dimension of said one or more microdots is less than 100 μm.

19. A method for facilitating identification of an item, said method comprising the steps of:
providing a plurality of taggants for associating with said item, each of said plurality of taggants comprising identical data for uniquely identifying said item; and
adapting said plurality of taggants to emit a response to a predefined activating condition;
wherein said plurality of taggants are of sufficiently small dimensions to be substantially imperceptible to a human being in the absence of said predefined activating condition.

20. The method of claim 19, wherein said step of adapting said plurality of taggants comprises applying a coating to said plurality of taggants.

21. The method of claim 19, wherein said step of adapting said plurality of taggants comprises overprinting said plurality of taggants with an ink.

22. An item comprising a plurality of taggants, each of said taggants comprising:
identical data for uniquely identifying said item; and
wherein each of said taggants is adapted to emit a response when subjected to a predefined activating condition; and
wherein each of said taggants is adapted to be substantially imperceptible to a human being in the absence of said predefined activating condition.

23. The item of claim 22, wherein said at least one taggant is substantially undetectable by a human being in the absence of said predefined activating condition.

24. The item of claim 22, wherein said at least one taggant is of sufficiently small dimensions to be unidentifiable by a human being in the absence of said predefined activating condition.

25. The item of claim 22, wherein the largest dimension of said at least one taggant is less than 1 mm.

26. The item of claim 22, wherein said at least one taggant comprises one or more microdots.

27. The item of claim 26, wherein the largest dimension of said one or more microdots is less than 100 μm.
